(19) United States
(12) Patent Application Publication
(10) Pub. No.: US 2025/0299507 A1
(43) Pub. Date: Sep. 25, 2025

(54) METHOD AND SYSTEM FOR RECOGNIZING ONE OR MORE LABELS

(71) Applicant: 3FRAMES SOFTWARE LABS PVT. LTD, Bengaluru, Karnataka (IN)

(72) Inventor: Rahul KUMAR, Bengaluru (IN)

(73) Assignee: 3FRAMES SOFTWARE LABS PVT. LTD, Bengaluru, Karnataka (IN)

(21) Appl. No.: 18/861,813

(22) PCT Filed: May 1, 2023
(86) PCT No.: PCT/IN2023/050421

§ 371 Date: Oct. 30, 2024

(30) Foreign Application Priority Data
Apr. 30, 2022 (IN) 202241023460

(51) Int. Cl. G06V 20/70; G06V 10/25; G06V 10/26; G06V 10/764; G06V 20/62

(52) U.S. Cl. CPC G06V 20/70; G06V 10/25; G06V 10/26; G06V 10/764; G06V 20/63

(57) ABSTRACT

Methods and systems for recognizing one or more labels are disclosed. The method includes receiving at least one image, wherein the at least one image includes one or more objects. The method also includes processing the received at least one image to detect the one or more objects and displaying the one or more labels in the received at least one image using the detected one or more objects.

### FIELD OF THE INVENTION

The present disclosure relates to the recognition of human-readable label(s) printed, engraved or embossed on the surface of an object during the production phase. More particularly, the disclosure relates to the capture of image or video data of a printed/engraved/embossed label on an object which would otherwise require human intervention.

### BACKGROUND

The present disclosure is concerned with label recognition. Labels can be found on virtually every product that is placed into commerce. The term “label” covers a wide variety of information that gets associated with products and comes in as many forms as people can envision. Labels include everything from tags that are permanently or temporarily affixed to products, serial numbers that get engraved into products, to nutritional information stuck to or printed onto a food product, just to name a few examples. Labels are used regularly throughout the commercial production process from the initial collection and transportation of materials all the way through production, and finally, into the shipping and delivery of an end product to a final consumer.

Labels whether printed on, engraved on, embossed on, or adhered to products during production are primarily devised for human understanding and consumption. As discussed above, labels are created on/in products at a variety of times during production, depending upon the production needs. This means that labels are quite often engraved directly into a material thereby creating informational markings having no color differentiation or informational markings that are directionally angled to accommodate product orientation. Humans have the ability to read and comprehend information on a label as they can adapt for environmental factors such as product placement, light, scale, orientation and even product or label damage. Humans also have the ability to account for and adapt to informational inadequacies which present difficulties for current label recognition systems.

Labels are regularly used during the production process to assure the right parts are included in the right product, that products and pieces are correctly directed, and finally that the right product is placed into the correct shipping box. The systems and methods as described herein can be used to improve label recognition anywhere along the product pipeline, however, verification of labels plays a vital role in the shipping industry to avoid mismatch during packaging of products in cardboard boxes and cartons. Pre-shipping label verification has been shown to substantially reduce the rejection rate of packages after shipping.

Product labels generally contain a set of words, numbers and/or symbols. In order for machine-based label verification to be useful, all of these words, numbers and symbols have to be correctly recognized with high precision and repeatability. Current label recognition methods mainly fall into two categories, image template matching or character recognition. In template matching, a set of templates are stored and characters on a label are matched to the stored templates. The template matching methods are fast but require exact alignment and frequent fine tuning. The template methods are highly susceptible to variations in illumination, changes in camera working distance from the object/product, and product orientation.

By contrast character recognition-based methods are less sensitive to light, scale, and orientation in the product environment, but approaches are computationally very expensive. Present character recognition systems can be limited as they do not allow selective recognition, and systems can be confused by special characters, non-contiguous markings, punctuation, color/font changes and the like. Character recognition systems are also notoriously inaccurate with damaged text or labels.

There remains a need for a label recognition system that is easy to use, relatively inexpensive and highly accurate in differing product environments. It is with respect to these and other considerations that the disclosure made herein is presented.

### SUMMARY

The disclosed subject matter includes systems, methods, and computer-readable storage mediums for recognizing one or more labels. The method includes receiving at least one image, where the at least one image includes one or more objects. The method also includes processing the received at least one image to detect the one or more objects and displaying the one or more labels in the received at least one image using the detected one or more objects.

Another general aspect is a computer system to recognize one or more labels. The computer system includes a memory and a processor coupled to the memory. The processor is configured to receive at least one image, where the at least one image includes one or more objects. The processor is also configured to process the received at least one image to detect the one or more objects and display the one or more labels in the received at least one image using the detected one or more objects.

An exemplary embodiment is a computer readable storage medium having data stored therein representing software executable by a computer. The software includes instructions that, when executed, cause the computer readable storage medium to perform receiving at least one image, where the at least one image includes one or more objects. The instructions may further cause the computer readable storage medium to perform processing the received at least one image to detect the one or more objects and displaying the one or more labels in the received at least one image using the detected one or more objects.

In one embodiment, a method for label recognition using image analysis is provided. The method includes receiving, from an image acquisition device, a label image containing one or more words or characters; determining, by a processor, if the label image includes a valid label; segmenting, by the processor, the label to identify groups of words or objects; searching, by the processor, based on the segmented label, for words or objects corresponding to the identified words or objects; providing, based on the searched words and objects, an output comprising a recognition score; then, optionally segmenting, by the processor, the identified words and objects to identify characters; searching, by the processor, based upon the characters, for characters corresponding to the identified characters; providing, based on the searched characters, an output comprising a recognition score; and providing, based upon the word and/or character recognition scores, a label identification.

In another embodiment, a system is disclosed. The system includes a processor; and a memory for storing computer executable instructions, the processor is configured to execute instructions to receive, from an image acquisition device, a label image containing one or more words or characters; determine if the label image includes a valid label; segment the label to identify groups of words or objects; search, based on the segmented label, for words or objects corresponding to the identified words or objects; provide, based on the searched words and objects, a recognition score; optionally segment the identified words and objects to identify characters; search, based upon the characters, for characters corresponding to the identified characters; provide, based on the searched characters, a recognition score; and provide, based upon the word and/or character recognition scores a label identification.

In another embodiment, a computer readable medium is disclosed. The at least one non-transitory computer readable medium is configured to store instruction that when executed by at least one processor included in a computing device, cause the computing device to perform a method comprising receiving, from an image acquisition device, a label image containing one or more words or characters; determining, if the label image includes a valid label; segmenting the label to identify groups of words or objects; searching, based on the segmented label, for words or objects corresponding to the identified words or objects; providing, based on the searched words and objects, a recognition score; then, optionally segmenting the identified words and objects to identify characters; searching, based upon the characters, for characters corresponding to the identified characters; providing, based on the searched characters, a recognition score; and providing, based upon the word and/or character recognition scores a label identification.

The systems, methods, and computer readable storage of the present disclosure overcome one or more of the shortcomings of the prior art. Additional features and advantages may be realized through the techniques of the present disclosure. Other embodiments and aspects of the disclosure are described in detail herein and are considered a part of the claimed disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates a block diagram of the system components according to one embodiment of the disclosure.

FIG. 2 depicts a computing environment for capturing label images in accordance with the present disclosure.

FIG. 3 depicts a cloud computing environment for use with the system modules as described.

FIG. 4 illustrates a block diagram of a word detection and prediction flow according to one embodiment of the disclosure.

FIG. 5 illustrates a block diagram of word level recognition and score prediction according to one embodiment of the disclosure.

FIG. 6 is a flow diagram for an embodiment of a process for recognizing one or more labels.

### DETAILED DESCRIPTION

In the following description, for purposes of explanation, numerous specific details are set forth to provide a thorough understanding of the present disclosure. It will be apparent, however, to one skilled in the art that the present disclosure can be practiced without these specific details. In other instances, systems and methods are shown in block diagram form only to avoid obscuring the present disclosure.

Reference in this specification to “one embodiment” or “an example embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure. In addition, the sequence of operations of the method need not be necessarily executed in the same order as they are presented. Further, one or more operations may be grouped together and performed in the form of a single step, or one operation may have several sub-steps that may be performed in parallel or in sequential manner.

In the following discussion and in the claims, the terms “including,” “comprising,” and “is” are used in an open-ended fashion, and thus should be interpreted to mean “including, but not limited to.”

The present invention seeks to provide a solution to the product label content recognition problem by providing a label detection and segmentation system that detects and segments a label from a captured image. The disclosed subject matter includes systems, methods, and computer-readable storage mediums for recognizing one or more labels. The method includes receiving at least one image, where the at least one image includes one or more objects. The method also includes processing the received at least one image to detect the one or more objects and displaying the one or more labels in the received at least one image using the detected one or more objects

As used herein “label” refers to anything associated with a product providing information about that product and includes all forms of indicia which can be the subject of recognition. Labels that can be processed using the systems and methods as described can be brand labels, healthcare labels, industrial labels, circuit labels, informative labels, descriptive labels, grade labels, compliance labels, or shipping labels. Labels include engraved or embossed indicia, printed matter, tags, stickers, barcodes, and the like.

The results analysis module determines whether the label, word, symbol or character is a match to the data associated with the product being scanned. Preferably, the word level score can be given more weight over the character level score for fixed words that do not change over time. On the other hand, character-level score can be given more weight over word-level scores for variable words that change over time. Weighting and error tolerance can vary depending upon the product being scanned, and the skilled artisan would understand how to set such error tolerances based upon product particulars. The particulars of error tolerance will depend upon the product being scanned and the risk profile of the customer.

As used herein characters can include numbers, letters and any special symbols as product labels routinely include information on the manufacturer, the manufacturing date, and the batch or product identification codes. Some products may include trademarks or other symbols of identification.

The label detection and segmentation module searches for a label or a set of labels in the capture image frame and produces a segmented label(s), the word detection and segmentation module searches for a set of words and provides segmented words, the word recognition module recognizes the word and generates its score for each word. The character recognition module takes it one level forward and recognizes each character in the segmented word and produces its score. The decision module can evaluate accuracy either solely based on word-level recognition scores or based on both word and character-level recognition scores.

In one embodiment, a system is provided for use in a typical human-readable product label recognition area both in controlled and uncontrolled industrial environments. These labels are generally printed/engraved/embossed on the surface of a product during the production phase. They may have a low print quality, smudge, skew and warp, uneven spacing between lines, font and style variation, and scaling that makes label content recognition very difficult. In addition, variation in illumination intensity and product placement/orientation adds another layer of complexity. Illumination and product placement can be controlled in a fully automated product inspection pipeline; however, it is almost impossible to control if a human is in the loop, which is often required. This invention resolves these problems by combining label level, word level, and character-level recognition mechanisms. The systems and methods as described comprise a plurality of machine learning and deep learning based trainable modules to segment the output of the image acquisition device and recognize objects of interest at multiple levels.

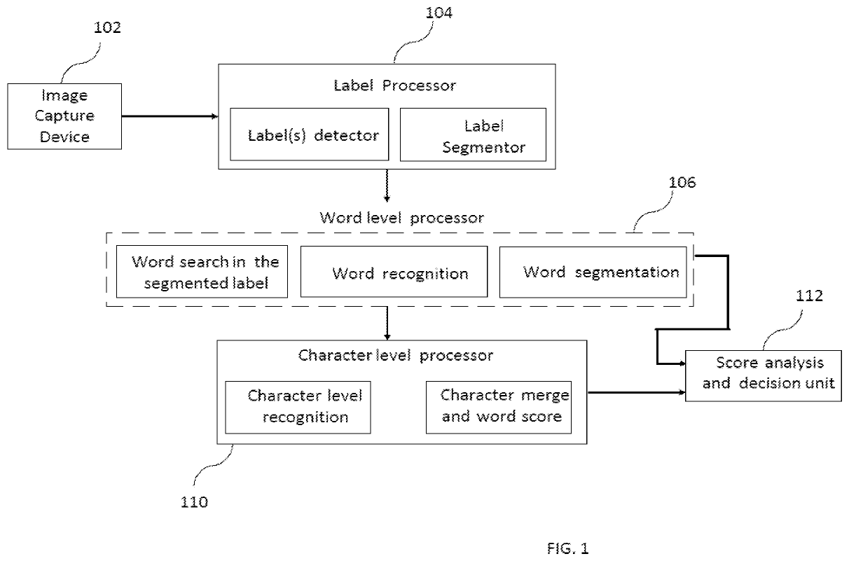

FIG. 1 illustrates a block diagram of a system in accordance with some embodiment of present disclosure. FIG. 1 provides a general overview of the systems as described herein. A product label is captured by an image capture device 102. The image capture device may be any type of capture device including but not limited to a digital camera, video camera, smartphone camera, tablet camera, laptop camera, security camera, cc tv and the like. The image capture device 102 can be installed for use with the described system or may be chosen from an image capture device already installed within a production facility. An image of the product label is captured by the image capture device 102 and is sent to a label processor 104. The image capture may be carried out on a continuous basis, for example, a video camera capturing products as they move along an assembly line, or the image capture may be triggered by one or more sensors or locators that inform the system that a product has entered the capture space. In either instance, the image capture may include video or still frames so long as the label information is included in the captured image. In one embodiment, the image is stored and accessed from a memory device.

During label processing, the information on the label is detected by a label(s) detector and one or more words or symbols on the label are segmented by a label segmentor. The segmented label information is sent to a word level processor 106 where the segmented label is compared to words in a training database to identify any words that appear on the label. Likewise, objects on the label can be processed at this level and compared to learned objects in a training database to identify any objects that appear on the label. The system may be trained and/or retrained on each individual product or the system may be set for continuous learning so that each new product/object/symbol or label is retained and recognized by the system.

In one embodiment, the system can be trained to look for informational inadequacies including missing or damaged information. In this embodiment, the system may be trained on a library of labels or may be untrained and used to segment and capture words and/or characters on the label. In one embodiment, if the system is trained, the word level processor 106 can identify information that is expected to be associated with a particular label and flag any labels that do not include the appropriate information. In an alternative embodiment, when the system in untrained, the word level processor 106 may create output that corresponds to the label and then match that information to a label library which would then allow any missing information of inconsistencies to be revealed and flagged.

In one embodiment, once words and/or objects on the label are identified, the accuracy of the identification can be scored known as word confidence score and these scores can be provided to a analysis and decision unit 112. In another embodiment, if the information gleaned from the label is insufficient to obtain a sufficient result to be scored, the system can be set to remove such a product for immediate human review.

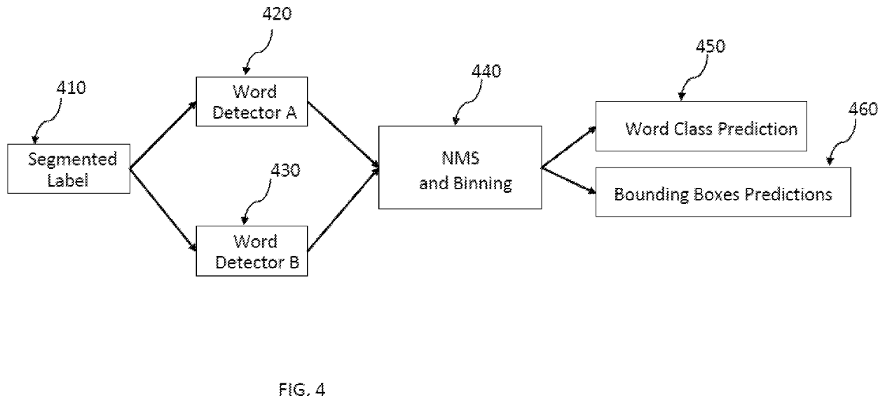

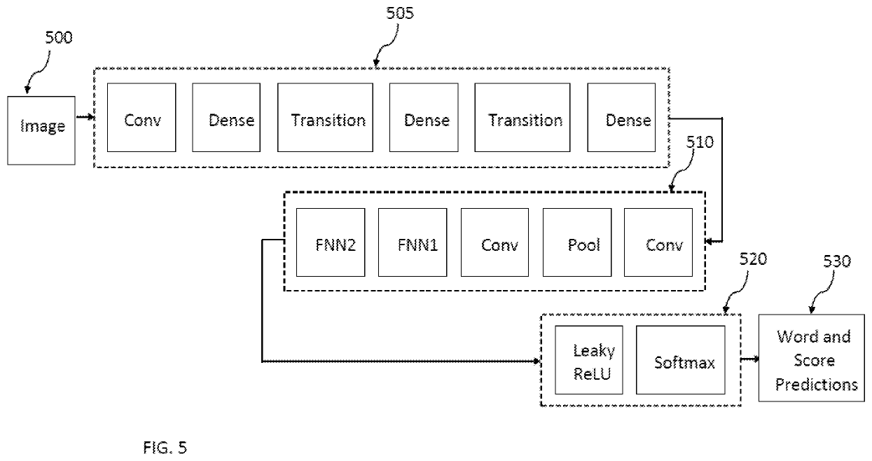

The words and/or objects identified in the word level processor 106 can then optionally be segmented into characters and sent to a character level processor 110 where they are further analyzed for accuracy. At the character level, the individual characters or parts of an object can be compared to a training database to identify them with more particularity. As the characters are identified, their accuracy can be scored known as character level confidence score and used to confirm or supersede the information developed at the word level. The merged word confidence score and the character level confidence scores can be evaluated by the analysis and decision unit 112, which decides whether the label information matches the known label information of the product at issue. Examples of specific modules and analysis techniques will be discussed further with regard to FIGS. 4 and 5.

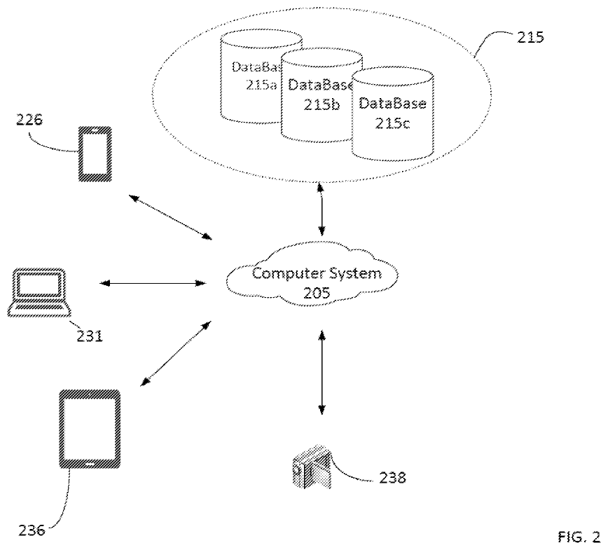

FIG. 2 illustrates a capture network for use in the embodiments described. As seen in FIG. 2, the product label may be captured by any manual or automated image capture device. FIG. 2 illustrates a smartphone 226, a laptop, 231, a tablet 236, and a camera 238, digital or otherwise. As discussed above, any recognized image capture device can be used in the embodiments as described. The images captured are sent to a computer system 205.

The computer system 205 may include one or more processor(s), and a memory communicatively coupled to the one or more processor(s). The one or more processor(s) are collectively a hardware device for executing program instructions (aka software), stored in a computer-readable memory (e.g., the memory). The one or more processor(s) may embody a custom made or commercially-available processor, a central processing unit (CPU), a plurality of CPUs, an auxiliary processor among several other processors associated with the computer system 205, a semiconductor based microprocessor (in the form of a microchip or chipset), or generally any device for executing program instructions.

The computer system 205 may operatively connect to and communicate information with one or more internal and/or external memory devices such as, for example, one or more databases 215 via a storage interface. The storage interface can also connect to one or more memory devices including, without limitation, one or more other memory drives including, for example, a removable disc drive, a computing system memory, cloud storage, etc., employing any art recognized connection protocols, for example a universal serial bus (USB), fiber channel, small computer systems interface (SCSI), etc.

The memory can include random access memory (RAM) such as, for example, dynamic random access memory (DRAM), synchronous random access memory (SRAM), synchronous dynamic random access memory (SDRAM), etc., and read only memory (ROM), which may include any one or more nonvolatile memory elements (e.g., erasable programmable read only memory (EPROM), flash memory, electronically erasable programmable read only memory (EEPROM), programmable read only memory (PROM), tape, compact disc read only memory (CD-ROM), etc.). Moreover, the memory can incorporate electronic, magnetic, optical, and/or other types of non-transitory computer-readable storage media. In some example embodiments, the memory may also include a distributed architecture, where various components are physically situated remotely from one another, but can be accessed by the one or more processor(s).

The instructions in the memory can include one or more separate programs, each of which can include an ordered listing of computer-executable instructions for implementing logical functions. The instructions in the memory can include an operating system.

The computer system 205 may include one or more network adaptor(s) enabled to communicatively connect the computer 205 with the one or more network(s). In some example embodiments, the network(s) may be or include a telecommunications network infrastructure. In such embodiments, the computer system 205 can further include one or more communications adaptor(s). The communications adapter(s) can include a global positioning system (GPS), cellular, mobile, and/or other communications protocols for wireless communication.

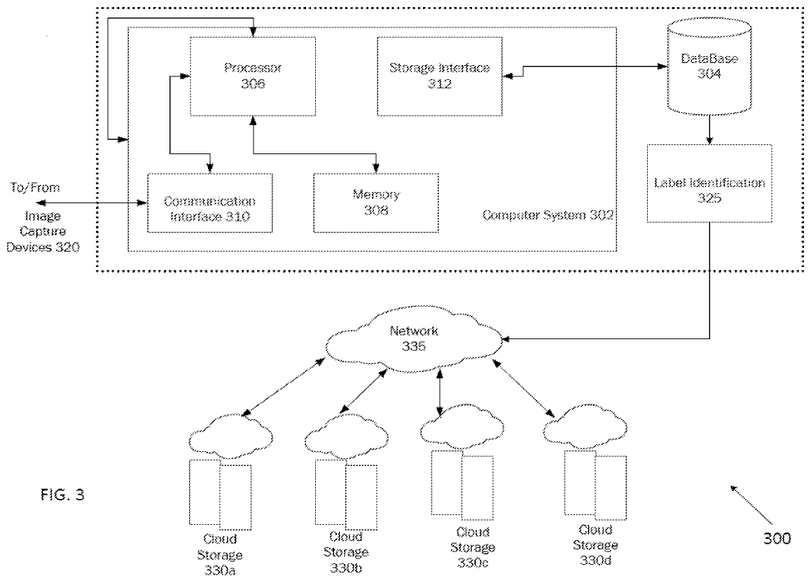

FIG. 3 depicts a cloud computing environment in accordance with the present disclosure. It is understood in advance that although this disclosure includes a detailed description on cloud computing, implementation of the teachings recited herein are not limited to a cloud computing environment. Rather, embodiments of the present invention may be implemented in conjunction with any other type of computing environment.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and rapidly released with minimal management effort or interaction with a provider of the service.

Cloud computing services that can be used with the methods and systems disclosed include on-demand self-service where a cloud consumer can unilaterally provision computing capabilities, such as server time and network storage, as needed automatically without requiring human interaction with the service's provider; broad network access where capabilities are available over a network (e.g., one or more network(s) 335, as depicted in FIG. 3) and accessed through standard mechanisms that promote use by heterogeneous thin or thick client platforms (e.g., mobile phones, laptops, and personal data assistants (PDAs)); or resource pooling where the provider's computing resources are pooled to serve multiple consumers using a multi-tenant model, with different physical and virtual resources dynamically assigned and reassigned according to demand.

Cloud service are useful for the instant systems and methods as they have rapid elasticity and can automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

The systems and methods as described can be monetized and distributed using any art recognized methodology and architecture. For example, the system may be run locally or via the cloud in any form including Software as a Service (SaaS); Platform as a Service (PaaS); Infrastructure as a Service (IaaS); or Database as a Service (DBaaS). The systems and method as described can be run on a private cloud, a community cloud, a public cloud or a hybrid cloud system as desired.

Referring to FIG. 3, FIG. 3 is a block diagram that illustrates a server 300, which may be an example of the computer system 205, as described in FIG. 2. The server 300 includes a computer system 302, one or more databases 304 and a file storage module 325.

The computer system 302 is operatively coupled to an image capture device 320 via a communication interface 310 which receives label information and data from the image capture device 320 in the form of still or video images.

The computer system 302 includes a processor 306 which includes executing instructions for segmenting the information found in the captured images to first identify the label and then to identify words or symbols within the image and compares those words or symbols to a database to identify the information on the label.

According to one embodiment, the processor 306 includes instructions associated with the label processor 104, the word processor 106, the character level processor 110, and the analysis and detection unit 112. The user may interact with the processor using any art recognized method, for example, a dashboard or web-site, using any art recognized device including, but not limited to, a handheld computer or tablet, a smart phone, a keyboard, or any other interface.

Instructions may be stored in, for example, but not limited to, a memory 308. The processor 306 may include one or more processing units (e.g., in a multi-core configuration). As shown in FIG. 3, the processor 306 may also be operatively coupled to the database 304. The database 304 is any computer-operated hardware suitable for storing and/or retrieving data. In some embodiments, the database 304 is integrated within the computer system 302. For example, the computer system 302 may include one or more hard disk drives as the database 304. In other embodiments, the database 304 is external to the computer system 302 and may be accessed by the computer system 302 using a storage interface 312.

The processor 306 carries instructions for receiving, from an image acquisition device, a label image containing one or more words, symbols or characters; segmenting the label to identify groups of words or symbols; searching, based on the segmented label, for words or symbols corresponding to the identified words or symbols; providing, based on the searched words and objects, a word confidence score; then optionally segmenting the identified words and objects to identify characters; searching, based upon the characters, for characters corresponding to the identified characters; providing, based on the searched characters, a word level confidence score; and providing, based upon the word and/or character recognition scores, a label identification using a final score.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

As described herein, the systems and methods are used to analyze and verify complex labels that are very difficult to handle using ordinary OCR pipelines. The systems and methods as described can be used to verify labels having non-specific orientations, variations in print color, damage, and the like, even under difficult environmental conditions including low light. Furthermore, the system and methods as described can be used to address labels/packages that have heretofore required a human to read them. For example, the systems and methods can be fully automated e.g., only a conveyor line and image capture device, and nonetheless be used to analyze packages with deformities, uneven print, random skew, and rotation issues, all of which would have previously required a human operator either to read the label or, at the very least, to orient the package and place it under a camera so that it could be processed.

As described herein the systems and methods can be used to recognize and analyze labels on packages regardless of rotation, working distance, skew, and environmental factors. Moreover, the systems and methods as described can recognize and evaluate information provided in a host of common formats including different printer types, fonts, languages, and those including special characters and artwork. As the system is adaptable to the specific product or package to be verified, the system may be preloaded with information particular to the images to be analyzed, for example, trademarks or characters or it may be adapted for languages depending upon the country of use.

In one embodiment of the present disclosure, systems and methods include the label processor 104 that takes image input from a live camera or a memory device. In one embodiment, the label processor 104 detects a label based on a label library for the specific use case. This embodiment relies upon some features associated with template recognition and some features associated with character recognition. In this embodiment, the label processor 104 may be trained on particular label templates and layouts so that the system can recognize a particular type of label and be pre-programmed to understand where pertinent information may be located on the label. Using label pre-recognition, the system more easily identifies the information needed for verification and also allows multiple label features to be used simultaneously to aide in recognition and confirmation.

The label detection is performed using object recognition methods inspired from single-pass detection architecture. Object recognition refers to a collection of tasks that are used to identify objects from digital images. During object recognition, the system generally completes three different functions. The first is image classification, i.e., assigning a class to the object, or put more simply, identifying what the image is of. Next an object detection system will look to the image for both object detection and object localization. Object localization involves drawing a bounding box around one or more objects in an image. Object detection combines the first two actions and draws a bounding box around an object and assigns a classification to that object. According to one embodiment, the object recognition uses an efficient backbone, a convolutional Neural Network (CNN) based neck and CNN based head for trained label detection and its bounding boxes prediction. Object detection is used to account for and adapt for positional variations in the label location and/or different production scenarios resulting in differing label placement.

More particularly, the label processor 104 is a deep neural network trained using a library of valid labels from a label library to detect a specific set of labels just as a human operator would be taught to look for specific valid labels. The label processor looks for a set of labels, and if the label is detected in the captured product image, its bounding box coordinates are transferred to the subsequent stages (i.e., word and character processors) for further processing of the label content. The label processor acts like a filter that eliminates any unwanted clutter and sends only the required region of interest to the label content analysis modules. While this embodiment uses object classification to learn and validate a library of labels, in another embodiment, the same methods and systems as described can be used to read the label as a whole capturing and analyzing substantially all indicia.

In one embodiment, the output of label detection is fed to a segmentation module that uses the bounding boxes and coordinates of the label detector and segments-out cropped image(s) from the input image. In this embodiment, the cropped image(s) are checked for the statistical features of the label using a statistical analysis procedure which exploits human knowledge and experiences to filter out valid labels. If the label is a valid label based on the statistical analysis, it goes into a label correction module that performs image correction operations such as image intensity correction, skew and rotation detection and correction. The segmented and corrected labels are then sent to the word processor.

Once the label has been validated and the areas of interest bounded, either word level analysis alone, or in combination with character level analysis may be carried out. In embodiments where the label is segmented, individual areas deemed relevant are further analyzed. In embodiments where the label is not segmented, all words and/or characters may be subject to analysis and validation.

The word level processor 106 consists of word search, word recognition and word segmentation modules. Any recognized word recognition system may be used in the system as described. In the embodiment described, the word search module is a deep learning-based network that can be trained to detect a set of valid words for the particular use case. In the use cases where only a set of words such as “MFD”, “BATCH NO.”, “EXP. DATE”, etc. are needed, the word search module makes the whole process robust and fast. If a set of valid words are detected on the label, then it moves to the word recognition module otherwise an error flag is raised to indicate a missing or distorted word on the label. The word recognition module recognizes words based on a word library. The output score of the word level recognition module is transferred to the label analyzer module. In embodiments where character level analysis are required, the coordinates of the bounding boxes of each valid word are transferred to the character level processor.

In one embodiment, the output from the word analysis results in a score high enough that the object is considered verified without the need for additional processing. In other instances, the labels are subjected to further character level process.

The character level recognition is the lowest granularity in the methods as described herein. Characters are detected and segmented from the detected valid words. These characters are processed for recognition. The recognized characters are subsequently sent to a word merger module that combines the characters for word level comparison and validation. The output of this character level processing unit is collected by the scores analyzer module that processes the outputs of the word level and the character level processor to generate a final output that shows the success or failure of the verification of the printed label on a product.

While specific analysis techniques are described below for the image analysis described herein, it will be readily apparent to the skilled artisan that other existing or after developed digital object recognition techniques can be used in the systems and methods as claimed.

In one embodiment, image quality checks are carried out as described. Before sending an image to the label processing module, the images are first quantitively processed for quality checks such as intensity, contrast, edge preservation, etc. Techniques such as Laplacian, Average intensity value, NIQE, BRISQUE, PIQE, etc. can be employed for this purpose. In the embodiment as described average intensity values, Laplacian of Gaussian, and NIQE have been used. In one embodiment, the output scores of these three methods can be collated and analyzed and if the score lies in the satisfactory range, then the image is marked as good quality otherwise it is considered as a poor-quality image and a retake signal is generated by the image controller. The image average is defined as:

$$\overline{I} = {\sum }_{x ∈ i , j}^{H , W} I ( x ) \qquad ( 1 )$$

where Ī indicates average value of all the pixels in an image I(x). In one embodiment, blur check can be performed using Laplacian of the captured image. As Laplacian is a second order derivate, it is very sensitive to image noise. Therefore, in one embodiment, a Gaussian smoothing function is applied before using the Laplacian operator is applied to the image. The combined Laplacian and Gaussian operation is performed as:

$$L o G ( p , q ) = - \frac{1}{π {σ}^{2}} [ 1 - \frac{{p}^{2} + {q}^{2}}{2 {σ}^{2}} ] {e}^{- \frac{{p}^{2} + {q}^{2}}{2 {σ}^{2}}} \qquad ( 2 )$$

where LoG(p,q) indicates Laplacian of Gaussian centred around pixel position (p,q) and σ² refers to pixel variance in a local support. Apart from the average intensity and blur check, a perceptual model based blind image quality assessment metric can be applied to determine the quality of an input image by calculating distance between natural scene static (NSS) model and multivariate Gaussian (MVG) model fit to the features extracted from the input image.

$$d ( {μ}_{1} , {μ}_{2} , {C}_{1} , {C}_{2} ) = \sqrt{{( {μ}_{1} - {μ}_{2} )}^{T} - {( \frac{{C}_{1} + {C}_{2}}{2} )}^{- 1} ( {μ}_{1} - {μ}_{2} )} \qquad ( 3 )$$

where μ₁, μ₂ and C₁, C₂ are mean vector and covariance metrices of the natural MVG and input image MVG models. These three scores can be used to generate a combined score to select or reject the captured image for further processing.

In one embodiment, the label detection module detects, analyzes and segments the label information. By way of example, the label detection module can be employed to detect if a valid label is present on the product. For this purpose, object detectors such as Fast-CNN, RetinaNet, SSD, YOLO, etc. architectures can be utilized. For the label detection and segmentation, a single-shot detector model as a backbone that is fine tuned and trained for special purpose label detection and bounding boxes prediction operations can be used.

SSD works by dividing an input image into a grid of cells and predicting a set of bounding boxes and class scores for each cell. Each bounding box is represented by four coordinates (x, y, width, height) and each box is associated with a confidence score that indicates the likelihood of an object being present in that box. To make predictions, the network applies a series of convolutional layers to the input image, which generates feature maps at different resolutions. The feature maps are then fed to a set of convolutional layers that predict the class scores and bounding box offsets for each cell. During training, SSD uses a multi-task loss function that combines the classification and regression losses. The classification loss penalizes the network for incorrect class predictions, while the regression loss penalizes the network for inaccurate bounding box predictions.

The primary reason for using SSD for label detection is its performance and accuracy. In addition, label shape and size is predefined for each SKU which make it suitable for SSD model. The main idea behind SSD is to perform object detection in a single forward pass of a neural network, unlike some other methods that require multiple passes. This makes it computationally efficient and well-suited for real-time applications. Furthermore, the detected labels are checked for size and aspect ratio. If the detected label lies within the boundary conditions, it is considered as a valid label otherwise the label is rejected for further processing. These boundary conditions are extracted based on extensive study of the label sizes and shapes.

For the skew and rotation corrections, multiple approaches can be used such as a Hough transform, the hand craft feature based approaches, and/or deep learning-based approaches. The deep learning-based methods outperform other classical approaches; however, these methods require annotated training data and are computationally expensive. On the other hand, classical methods require less resources, but may produce erroneous results in some cases. Therefore, an angle-limiter module may be applied right after the angle-skew prediction block of a classical method. The angle of rotation prediction is performed using Hough transform on an edge detected output image. On top of the Hough transformed based angle predictor, we have applied an angle limiter. This angle limiter gives practical advantages over non-angle limiter approach. The angle limiter is described below:

$$δϕ = \{ \begin{matrix}θ & if \vert θ \vert \leq th \\ 0 & otherwise\end{matrix} \qquad ( 4 )$$

where δϕ indicates change of angle required to the input image, θ and th show the predicted angle change required by the angle predictor and allowed threshold value to limit this change, respectively.

$$\hat{ϕ} = ϕ + δϕ \qquad ( 5 )$$

where \hat{ϕ} and ϕ indicate final angle of the image after addition or subtraction of the required change from (4) and original angle, respectively.

As discussed above, in one embodiment, the target word detection on the label is carried out using a template type specialized function which requires detection of target words or symbols rather than generic text recognition that might be used in standard OCR text detection on the label. In this embodiment, the object detection architecture has been trained on specific sets of texts, labels, or other relevant datasets. In this embodiment, the text dataset can contain particular words that vary depending upon the particulars of the product and production scenario. In this embodiment, the words detector looks for the specified words and generates a prediction score and bounding boxes around the detected words.

FIG. 4. shows a flow of word search and bounding box predictions that are used for words segmentation/cropping from a label. First, a segmented label 410 comes from the label detection module. Two detectors, 420 and 430, are trained on a custom word library. This approach is designed to benefit from a dual detection and classification method. In this embodiment, EfficientDet and YOLO methods can be used to detect the words. EfficientDet is an object detection model introduced by Google Brain in 2019. It is based on the EfficientNet architecture, which is a family of neural networks designed for efficient model scaling by balancing the depth, width, and resolution of the network. The EfficientDet model uses a BiFPN (bidirectional feature pyramid network) architecture, which combines features from different levels of the feature pyramid to achieve better detection accuracy. It also uses anchor-free object detection, which eliminates the need for anchor boxes and reduce computational complexity. The YOLO architecture works by dividing the input image into a grid of cells and predicting bounding boxes and class probabilities for each cell. Each bounding box prediction consists of a set of coordinates that define the center of the object, the width and height of the object, and the confidence score that the predicted box contains an object. The output of these two methods can then be sent to a non-max suppression module that passes the best out of two based on IOU score.

A non-max suppression (NMS) and binning module 440 process the output of 420 and 430 to determine an optimal class and bounding boxes. The word search and segmentation can be done using a bucketing method. In a bucketing method, similar looking words are grouped into one bucket during training and inference, for example, “MFD” and “MRP” are in one bucket, while “Dec. 2, 2022” and “Jun. 9, 2022” are in another bucket, and special characters such as “&” and % are in yet another bucket, and so on. This makes the detection and category classification robust and fast.

Outputs 450 and 460 are the resulting predicted class and predicted bounding boxes coordinates, respectively. The class labels and bounding boxes captured from the word detection module are used to extract the words from a label image for next module processing, i.e., word recognition.

The word recognition is performed using a classification network. For words level recognition, a DenseNet backbone is employed, which is followed by a custom neck and head network depicted in FIG. 5. Module 500 is a segmented word image and module 505 indicates the DenseNet backbone architecture. Densenet is based on the idea of dense connections, which are connections between all layers in a block. Densenet introduces an approach where each layer is connected to every other layer in a block. This is achieved by concatenating the feature maps produced by each layer, instead of adding or averaging them, as is done in other architectures. Dense connections provide better feature representation and feature diversity, which improves the accuracy of the model. Densenet consists of multiple dense blocks, each of which is composed of several layers with dense connections between them. In addition, Densenet uses a transition layer between each dense block, which reduces the dimensionality of the feature maps before passing them to the next block. This helps to control the growth of the model and reduce its computational cost.

Module 510 and 520 are attached to learn specific features and predict a class and score, respectively. Conv and Pool indicates convolutional and pooling layers. FNN1 and FNN2 are fully connected neural network layers. Output 530 indicates the word class and prediction probability score. This word recognition mechanism recognizes curved and skew words also with high accuracy.

The word class prediction 450 and bounding boxes 460 are also shared with the character recognition module for character level processing.

Before applying the character recognition model, the segmented words are checked for connected-components. This improves accuracy for dot-matrix printed materials. If the connected component score is below a threshold level, then a pixel's connectivity operation is applied. Subsequently, a character recognition model such as convolutional recurrent neural network architecture (CRNN) can be employed.

The CRNN combines the power of convolutional neural networks (CNNs) and recurrent neural networks (RNNs) into a single model. The CNNs are used to extract features from the input data, while the RNNs are used to model the sequential nature of the data and capture temporal/contextual dependencies. In the case of text recognition, the CRNN takes an image as input and applies a series of convolutional layers to extract features. The output of the convolutional layers is then fed into a recurrent layer, such as a Long Short-Term Memory (LSTM) layer or GRU, to model the sequential dependencies between the features. Finally, a fully connected layer can be used to map the output of the recurrent layer to the output text classes. One important aspect of text recognition is handling variable-length sequences, as the length of the text in an image can vary. To handle this, the CRNN uses a technique called the Connectionist Temporal Classification (CTC) loss function, which allows for the model to output a sequence of characters without requiring alignment between the input image and output text.

This module takes input predictions from the word and character recognition modules, simultaneously. The word match score with probability score is utilized for analysis. The input from character recognition module is taken after word combination that is employed for cosine similarity matching score. These two scores are fed into a unified exponential probability function as given below:

$${( s , cat )}^{f} = {e}^{- β} \times {( s , cat )}^{w} + ( 1 - {e}^{- β} ) \times {( s , cat )}^{c} \qquad ( 6 )$$

where β is a weightage tunning parameter, (s,cat)^{f}, (s,cat)^{w} and (s,cat)^{c} are final score and category, word level recognition score and category, and character level recognition scores and category, respectively.

The word and character level processor scores weightage may vary based on the binning categories. If the words are variable in nature such as date and batch number, character recognition module is more weighted, whereas if the word is having special characters then word level recognition module is having more weightage. Appropriate methods for weighting outcomes will be readily apparent to the skilled artisan and any art recognized method may be used.

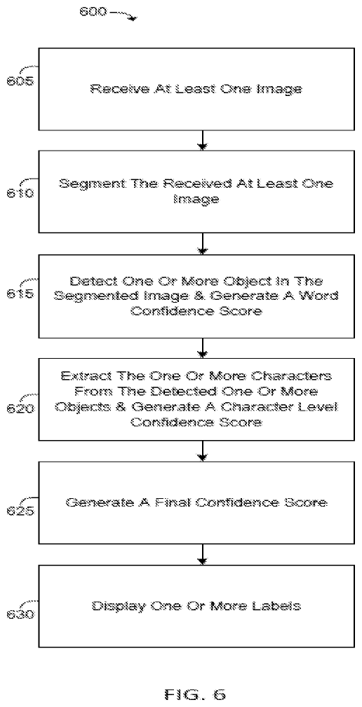

Referring to FIG. 6, FIG. 6 is a flow diagram 600 for an embodiment of a process for recognizing one or more labels. The process may be utilized by one or more modules or components in the system for recognizing one or more labels. The order in which the process/method 600 is described is not intended to be construed as a limitation, and any number of the described method blocks can be combined in any order to implement the method 600. Additionally, individual blocks may be deleted from the method 600 without departing from the spirit and scope of the subject matter described herein. Furthermore, the method 600 can be implemented in any suitable hardware, software, firmware, or combination thereof.

At step 605, the process may receive at least one image. In one embodiment, the at least one image is received from the image capture device 102. The at least one image may include one or more labels that need to be recognized.

At step 610, the process may segment the received at least one image. In order to segment the received at least one image, the label processor 104 is configured to assign a class to one or more objects in the received at least one image and predict a bounding box for each of the one or more objects. Finally, the label processor is configured to segment the received at least one image based on the bounding box.

At step 615, the process may detect one or more objects in the segmented image and the process may also generate a word confidence score for the detected one or more objects. In one embodiment, the word level processor 106 is configured to detect the one or more objects from the segmented at least one image by inputting the segmented at least one image to a plurality of models. By inputting the segmented at least one image to the plurality of models, the word level processor 106 determines a word confidence score for each model and selects the model having a highest word confidence score. Upon selecting the model, the word level processor 104 uses that particular model for detecting the one or more object and generating a word confidence score. In an optional embodiment, the analysis and decision unit 112 is configured to determine whether the generated word confidence score is above a threshold and confirm the detected one or more objects as the one or more labels when the generated word confidence score is above the threshold.

At step 620, the process may extract one or more characters from the detected one or more objects and the process may also generate a character level confidence score. In one embodiment, the character level processor 110 is configured to extract the one or more characters from the detected one or more objects and identify the one or more objects by combining the extracted one or more characters. The character level processor 110 is further configured to generate a character level confidence score for the identified one or more objects.

At step 625, the process may generate a final confidence score. In one embodiment, the analysis and decision unit 112 is configured to determine a binning category based on the detected one or more objects and identify a weightage tunning parameter based on the determined binning category. The analysis and decision unit 112 is further configured to generate a final confidence score based on the determined binning category, the identified weightage tunning parameter, the word confidence score, and the character level confidence score. Further, the analysis and decision unit 112 is configured to confirm the detected one or more objects as the one or more labels when the generated final confidence score is above the threshold.

At step 630, the process may display the one or more labels based on the confirmation in one of step 615 and 625.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A computer-implemented method, comprising:
receiving at least one image, wherein the at least one image includes one or more objects;
processing the received at least one image to detect the one or more objects; and
displaying the one or more labels in the received at least one image using the detected one or more objects.

2. The method as claimed in claim 1, wherein processing the received at least one image comprises:
assigning a class to one or more objects in the received at least one image;
predicting a bounding box for each of the one or more objects; and
segmenting the received at least one image based on the bounding box.

3. The method as claimed in claim 2, further comprises:
detecting the one or more objects from the segmented at least one image by inputting the segmented at least one image to a plurality of models; and
generating a word confidence score for the detected one or more objects.

4. The method as claimed in claim 3, wherein detecting the one or more objects from the segmented at least one image comprises:
inputting the segmented at least one image to each of the plurality of models to determine one or more temporary objects and a confidence score;
selecting a model from the plurality of models corresponding to a highest word confidence score; and
detecting the one or more objects from the segmented at least one image by inputting the segmented at least one image to the selected model.

5. The method as claimed in claim 3, further comprises:
determining whether the generated word confidence score is above a threshold; and
confirming the detected one or more objects as the one or more labels when the generated word confidence score is above the threshold.

6. The method as claimed in claim 3, further comprises:
extracting the one or more characters from the detected one or more objects;
identifying the one or more objects by combining the extracted one or more characters; and
generating a character level confidence score for the identified one or more objects.

7. The method as claimed in claim 6, further comprises:
determining a binning category based on the detected one or more objects; and
identifying a weightage tunning parameter based on the determined binning category;
generating a final confidence score based on the determined binning category, the identified weightage tunning parameter, the word confidence score, and the character level confidence score; and
confirming the detected one or more objects as the one or more labels when the generated final confidence score is above a threshold.

8. A system, comprising:
a memory; and
a processor coupled the memory and configured to:
receive at least one image, wherein the at least one image includes one or more objects;
process the received at least one image to detect the one or more objects; and
display the one or more labels in the received at least one image using the detected one or more objects.

9. The system as claimed in claim 8, wherein to process the received at least one image, the processor is configured to:
assign a class to one or more objects in the received at least one image;
predict a bounding box for each of the one or more objects; and
segment the received at least one image based on the bounding box.

10. The system as claimed in claim 9, wherein the processor is further configured to:
detect the one or more objects from the segmented at least one image by inputting the segmented at least one image to a plurality of models; and
generate a word confidence score for the detected one or more objects.

11. The system as claimed in claim 10, wherein to detect the one or more objects from the segmented at least one image, the processor is configured to:
input the segmented at least one image to each of the plurality of models to determine one or more temporary objects and a confidence score;
select a model from the plurality of models corresponding to a highest word confidence score; and
detect the one or more objects from the segmented at least one image by inputting the segmented at least one image to the selected model.

12. The system as claimed in claim 10, wherein the processor is further configured to:
determine whether the generated word confidence score is above a threshold; and
confirm the detected one or more objects as the one or more labels when the generated word confidence score is above the threshold.

13. The system as claimed in claim 10, wherein the processor is further configured to:
extract the one or more characters from the detecting one or more objects;
identify the one or more objects by combining the extracted one or more characters; and
generate a character level confidence score for the identified one or more objects.

14. The system as claimed in claim 13, wherein the processor is further configured to:
determine a binning category based on the detected one or more objects; and
identify a weightage tunning parameter based on the determined binning category;
generate a final confidence score based on the determined binning category, the identified weightage tunning parameter, the word confidence score, and the character level confidence score; and
confirm the detected one or more objects as the one or more labels when the generated final confidence score is above a threshold.

15. At least one non-transitory computer readable storage medium configured to store instructions that, when executed by at least one processor included in a computing device, cause the computing device to perform a method for recognizing one or more labels comprising:
receiving at least one image, wherein the at least one image includes one or more objects;
processing the received at least one image to detect the one or more objects; and
displaying the one or more labels in the received at least one image using the detected one or more objects.

16. The computer readable storage medium as claimed in claim 15, wherein processing the received at least one image comprises:
assigning a class to one or more objects in the received at least one image;
predicting a bounding box for each of the one or more objects; and
segmenting the received at least one image based on the bounding box.

17. The computer readable storage medium as claimed in claim 16, further comprises:
detecting the one or more objects from the segmented at least one image by inputting the segmented at least one image to a plurality of models; and
generating a word confidence score for the detected one or more objects.

18. The computer readable storage medium as claimed in claim 17, wherein detecting the one or more objects from the segmented at least one image comprises:
inputting the segmented at least one image to each of the plurality of models to determine one or more temporary objects and a confidence score;
selecting a model from the plurality of models corresponding to a highest word confidence score; and
detecting the one or more objects from the segmented at least one image by inputting the segmented at least one image to the selected model.

19. The computer readable storage medium as claimed in claim 17, further comprises:
determining whether the generated word confidence score is above a threshold; and
confirming the detected one or more objects as the one or more labels when the generated word confidence score is above the threshold.

20. The computer readable storage medium as claimed in claim 17, further comprises:
extracting the one or more characters from the detected one or more objects;
identifying the one or more objects by combining the extracted one or more characters; and
generating a character level confidence score for the identified one or more objects.

21. The computer readable storage medium as claimed in claim 20, further comprises:
determining a binning category based on the detected one or more objects; and
identifying a weightage tunning parameter based on the determined binning category;
generating a final confidence score based on the determined binning category, the identified weightage tunning parameter, the word confidence score, and the character level confidence score; and
confirming the detected one or more objects as the one or more labels when the generated final confidence score is above a threshold.
